(19) United States
(12) Patent Application Publication
(10) Pub. No.: US 2013/0008941 A1
(43) Pub. Date: Jan. 10, 2013

(54) Beverage Counter

(76) Inventors: Gerald L. Morris, Oak Forest, IL (US); Harold M. Morris, Oak Forest, IL (US); Sandra L. Talchik, Midlothian, IL (US)

(21) Appl. No.: 13/176,906

(22) Filed: Jul. 6, 2011

(51) Int. Cl. G01G 23/18

(52) U.S. Cl. 235/1 R

(57) ABSTRACT

A beverage counter for keeping track of the number of beverages consumed. The beverage counter has a region for contact with a beverage container. The portion for contact with a beverage container can be a sleeve which surrounds the exterior of the beverage container. The sleeve may have insulating properties. As the beverage is inserted into the sleeve, the insertion triggers a counting mechanism to increase the count displayed on the count mechanism by one. The counting mechanism may be a mechanical counter, or an electrical counter, or an optical counter. Once a consumed beverage is removed from the sleeve, inserting a new beverage into the sleeve increases the beverage count by one again. A counter reset button is used to reset the count cycle.

### FIELD OF THE INVENTION

This invention relates to the field of beverage container devices, and in particular beverage container devices which keep track of beverage consumption.

### BACKGROUND OF THE INVENTION

There are various circumstances under which a person may want to keep track of their beverage consumption. For example, a person may want to keep track of the amount of water they consume to ensure that their consumption meets the minimum daily recommended amount. Others may want to keep track of the amount of coffee or other beverages they consume throughout the day for health or dietary reasons.

Beverage containers with counters are available for keeping track of the amount of beverages consumed. However, many beverage containers have counters which require the user to manually adjust the counter to reflect an increased count. Many beverage containers with counters also do not allow the user to consume the beverage in the container the beverage originally came in, but rather require the user to empty the contents of the beverage from the original container into the beverage container with a counter. This is often troublesome and time consuming, especially for hot liquids or carbonated beverages.

The present inventors have recognized the need for a beverage counter which can keep count of the number of beverages consumed without requiring the user to manually keep track of the number of beverages consumed.

The present inventors have recognized the need for a beverage counter which allows the user to keep the beverage in its original container while maintaining count of the number of beverages consumed.

The present inventors have recognized the need for a beverage counter which assists in minimizing the beverage's change in temperature.

### SUMMARY OF THE INVENTION

A beverage counter comprises a region in contact with a beverage container. The region in contact with a beverage container can be a sleeve which surrounds at least a portion of the beverage container. A counting mechanism is engaged with the contact region of the beverage counter. A user keeps track of the number of beverages consumed via the display indicator on the counting mechanism.

The display indicator of the counting mechanism is disposed in contact with the sleeve such that the numerical count is visibly displayed from the sleeve. The counting is mechanism is triggered to increase the count by one each time a beverage comes in contact with the contact region, such as by inserting a beverage container into the sleeve.

Various daunting mechanisms can be used. Counting mechanisms can be mechanical, or electronic, optical, or sonic. Any other suitable counter may be used.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates a perspective view of an exemplary embodiment of the beverage counter.

FIG. 2 illustrates a cross sectional perspective view of the exemplary embodiment of FIG. 1.

FIG. 2a illustrates a side view of a counting mechanism.

FIG. 3 illustrates another embodiment of the beverage counter.

FIG. 4 illustrates an alternate embodiment of the beverage counter

FIG. 5 illustrates another embodiment of the beverage counter.

FIG. 6 illustrates another embodiment of the beverage counter.

FIG. 7 illustrates an exploded view of the beverage counter.

FIG. 8 illustrates a perspective view of an alternate arrangement of a counting mechanism.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

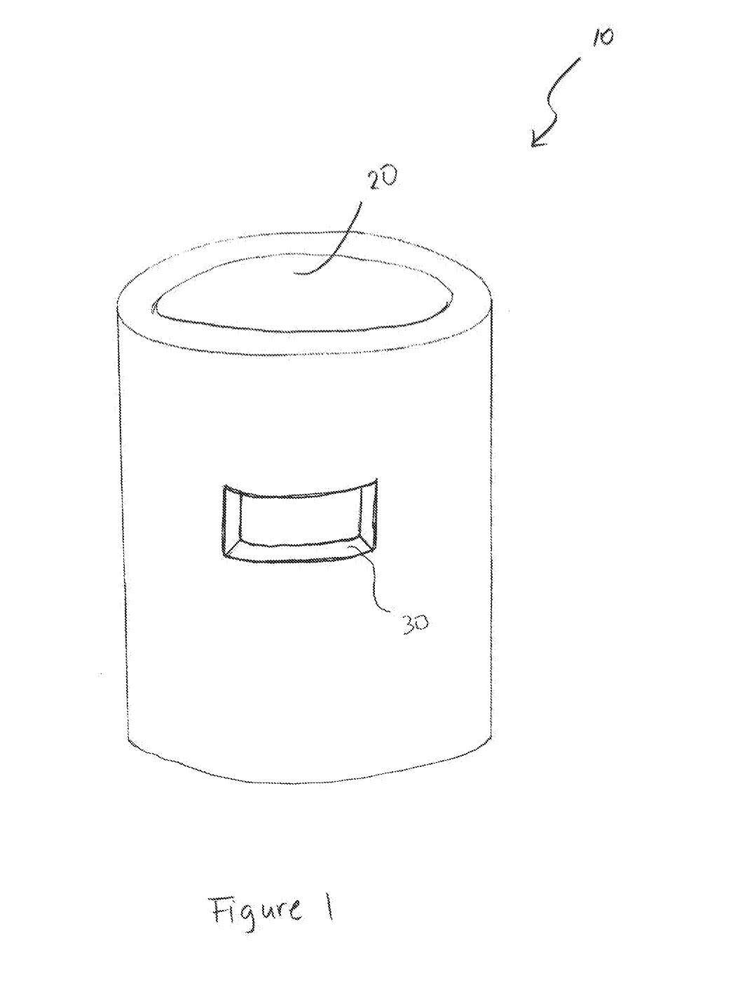

FIG. 1 illustrates a perspective view of one embodiment of the beverage counter. The beverage counter 10 has a beverage contact region in the form of a sleeve 20. Sleeve 20 comprises a display window 30 for presenting the numerical value displayed by a counter from beneath the surface of the sleeve 20. A counter reset may also protrude from beneath the surface of the sleeve 20 to be accessible by the user. The sleeve 20 is cylindrical and of a size suitable for use with various beverage containers, such as beer cans or bottles, water bottles, cups of coffee or tea, and soda cans. In other embodiments, the beverage contact region need not be a sleeve which surrounds the entire circumference of a beverage container.

The sleeve may be made of an insulating material to maintain the temperature of the beverage, or to decrease the temperature of the beverage. The sleeve can be made of a waterproof material. The sleeve may be made of a flexible foamed material, such as polypropylene, and can have elastic properties to provide a snug fit to accommodate beverage containers of various sizes.

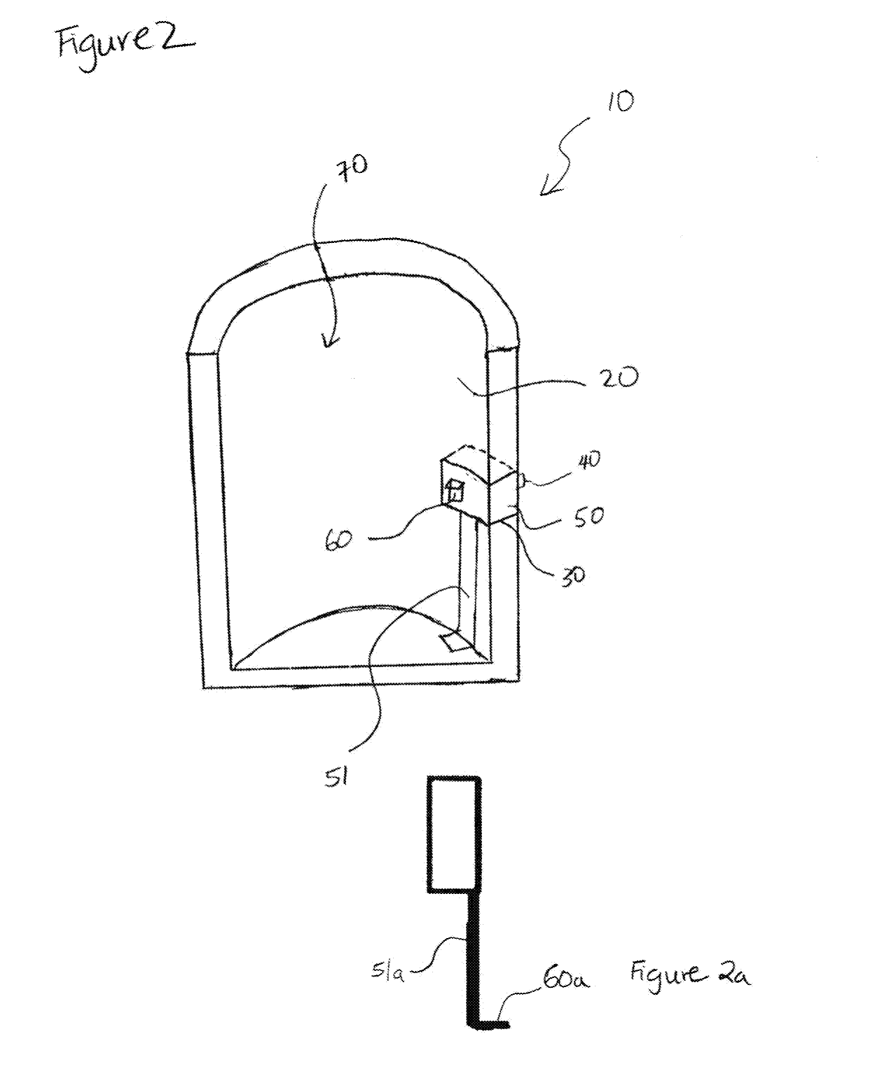

FIG. 2 illustrates a perspective cross sectional view of the beverage counter with a counting mechanism 50 disposed within the wall of the sleeve 20. In the embodiment illustrated in FIG. 2, the counting mechanism is a mechanical counter. The counter 50 in FIG. 2 comprises a lever 60 which extends into the interior space 70 of the cylindrical sleeve. The lever 60 is a lever which when depressed, increases the count displayed on mechanical counter by one. Lever 60 is oriented such that when a beverage container is placed in the sleeve, the downward motion of placing the beverage container in the sleeve depresses the lever as the beverage container moves downward and past the lever. Thus, the count number increases by one each time a new beverage is placed into the sleeve. After the contents in the beverage container are consumed, the beverage container is removed. Removal of the beverage container allows the lever to move from its depressed position to an elevated position. Once in an elevated position, the lever 60 is ready to be depressed as the next beverage container is inserted into the sleeve.

To reset the counter, for example when a predetermined amount of time has been reached, or when a pre-determined event has occurred, the user may reset the counter by, for example, pressing a reset button 40 which as illustrated in FIG. 2, is accessible from the exterior of the sleeve 20. Alternatively, depending on the counting mechanism used, the reset button may be accessible from the interior space 70 of the sleeve.

The counting mechanism is maintained in position within the wall of the sleeve. The counting mechanism may be secured into position using an adhesive, or by mechanical engagement with the display window 30. The counting mechanism may also be secured into position using a support bar 51, extending along at least a portion of the wall of the sleeve. Support bars may support the weight of the counting mechanism and/or maintain the counting mechanism in a stationary position relative to the wall of the sleeve such that the numerical display on the counter maintains its alignment with the display window 30 of the sleeve 20. In another embodiment, the counting mechanism may be as illustrated in FIG. 2a. The counting mechanism is supported by a support bar 51a. A lever 60a which extends from the support bar 51a at the base of the support bar can be used to stabilize the counting mechanism, and/or can be used as a lever which when depressed, increases the count displayed by one.

In another embodiment, the region proximate to the counting mechanism may be made of a different material than the sleeve to sustain the weight of the counting mechanism. The region on which the counting mechanism rests over may be made of a material sufficient to support the counting mechanism to prevent the region below the counting mechanism from collapsing from the weight of the counting mechanism. In some embodiments the material selected for the sleeve is of sufficient strength to support the counter in position.

A mechanical counter can be of the type described in, or derived from, U.S. Pat. Nos. 1,385,410; 2,572,784; 5,063,285; 3,811,032; 3,421,690; 3,006,546, herein incorporated by reference, or the mechanical counter can be a commercially available counter such as the Advanced Hand Counter, product code MS504 sold by MiniScience.com.

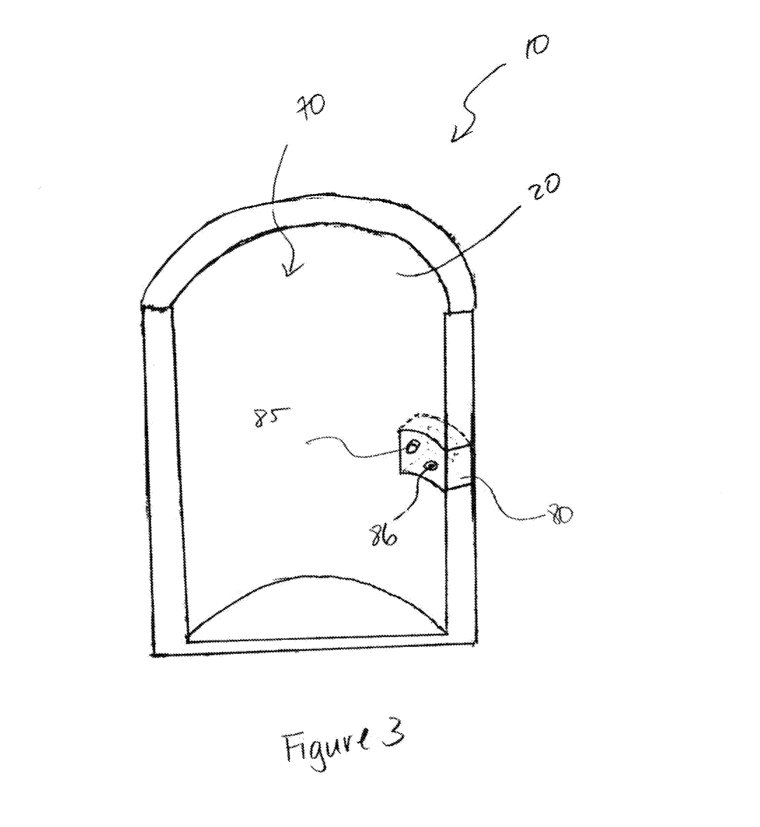

The counting mechanism can be any type of counting mechanism such as an electrical counting mechanism, or an optical counting mechanism. Any other suitable counting mechanisms, or a combination thereof, can also be used FIG. 3 illustrates another embodiment of the beverage counter with a counting mechanism 80 disposed within the wall of the sleeve. In the embodiment illustrated in FIG. 3, the counter mechanism 80 is an electrical counter, such as one with a digital display. The electrical counter can be a commercially available counter such as the Digital Tally Counter, product code ECTR; Digital Counter, product code DCTR; or Digital Hand Counter, product code DIGICTR, all sold by MiniScience.com. The electrical counter 80 can comprise a contact point, such as a button 85, which when triggered by depressing, increases the count number displayed on the counting mechanism by one. The button 85 extends into the interior space of the sleeve 70 such that when a beverage container is inserted into the sleeve, the downward motion of the beverage container depresses the button 85. The button may be made of a soft material or flexible material such as plastic, rubber, and the like, to withstand wear and tear of repeated use.

The button may be shaped to have an incline to better allow the beverage container to depress the button as the beverage container is moved downwards into the sleeve. A reset button 86 for resetting the counter may be disposed also within the interior space of the sleeve. The reset button may be recessed to prevent accidental resetting of the counter during insertion or removal of the beverage container. Alternatively, the reset button may be displayed on the exterior surface of the sleeve. The reset button can also be recessed from the surface of the sleeve to prevent accidental depression and thus resetting, of the counter. The display on the counter is visible from the exterior surface of the sleeve due to a window portion that allows the counter display to be visible. The visibility of the counter display of the counting mechanism behind the exterior surface of the sleeve 20 can be due to a removed portion of the exterior sleeve, thus Lilting in a display window 30 (FIG. 1), or due to a transparent portion of the sleeve, or a combination thereof. Any other suitable method of displaying the counter display to the user can be used.

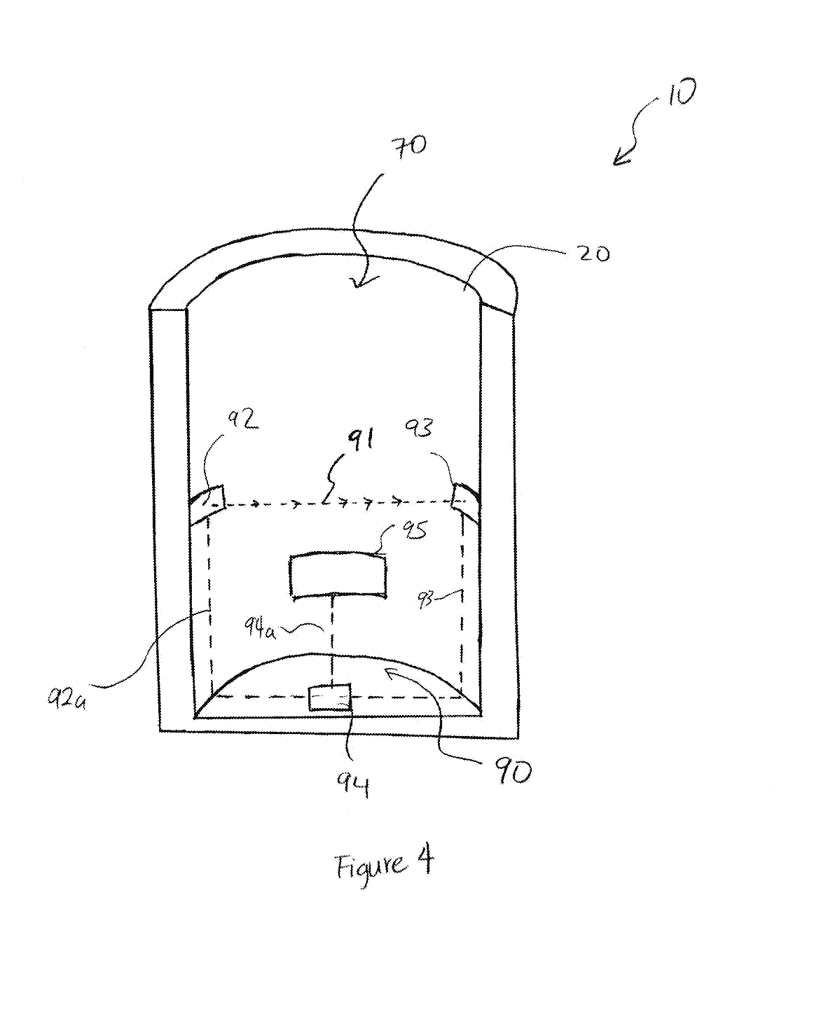

FIG. 4 illustrates a perspective cross sectional of the beverage counter with a schematic diagram of an optical counting mechanism referred to generally as 90. In the embodiment illustrated in FIG. 4, the counting mechanism is an optical counter with a source 92 to provide a continuous beam 91 across an arc of the cylindrical cross section of the interior space 70 of the sleeve 20. When a beverage container is inserted within the interior space of the sleeve, the beam is interrupted. A sensor 93 senses the interruption of the beam 91, and causes a signal to be transmitted to a microprocessor 94 which causes the count displayed on the display indicator 95 to increase by one. Removal of a beverage container when the contents have been consumed allows the beam to be received by the sensor 93 again. A new beverage container inserted into the sleeve would interrupt the beam again to trigger the next count increase. A reset button (not shown) may be disposed on the interior or exterior of the sleeve as described above to restart a new count cycle. As illustrated in FIG. 4, the sensor and the source of the beam are disposed diametrically opposite. However, any position of the source and sensor can be used. The source and sensor can be placed anywhere along the circumference of the cylinder to intersect the interior space 70 of the sleeve. The source and sensor may be placed the same distance from the bottom of the cylindrical sleeve. Alternatively the source and sensor may be placed such that an optical beam is diagonal along the interior space of the sleeve. Any configuration of the optical beam can be used to provide a beam pathway which can be interrupted by the insertion of a beverage container.

Signal from the sensors to the microprocessor and to the display indicator 95 can be communicated by wires 92a, 93a, 94a. Such wires can be embedded within the walls of the cylindrical sleeve. The wires may be embedded within the vertical walls of the cylindrical sleeve, and/or the bottom wall of the cylindrical sleeve.

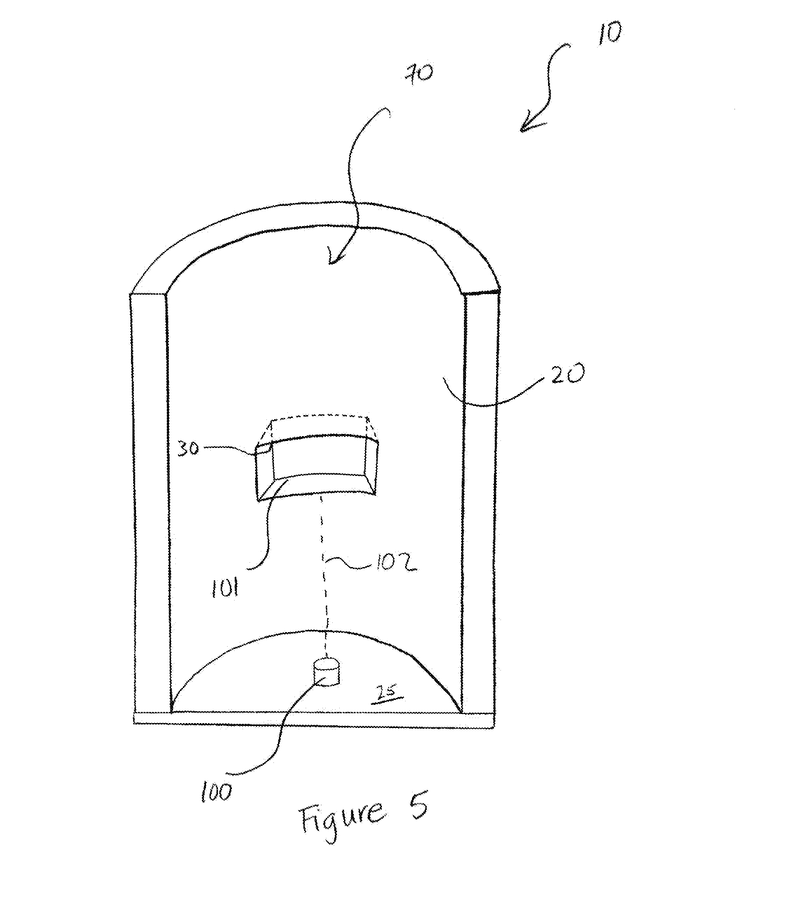

In the embodiment illustrated in FIG. 5, an electrical counter 101 is used. A button 100 which is depressed to increase the count number displayed is located on the bottom surface 25 of the cylindrical sleeve 20. The button protrudes sufficiently from the bottom surface of the cylindrical sleeve to make contact with the bottom of various beverage containers. Many beverage containers have a concaved bottom surface. In order to make contact with the concaved bottom surface, a button on the bottom of the sleeve can extend upward a sufficient distance. When a beverage container is inserted into the sleeve, the bottom surface will make contact with the button, causing the button to depress and send a signal 102 to the main circuitry of the electronic counter 101, to increase the count display by one.

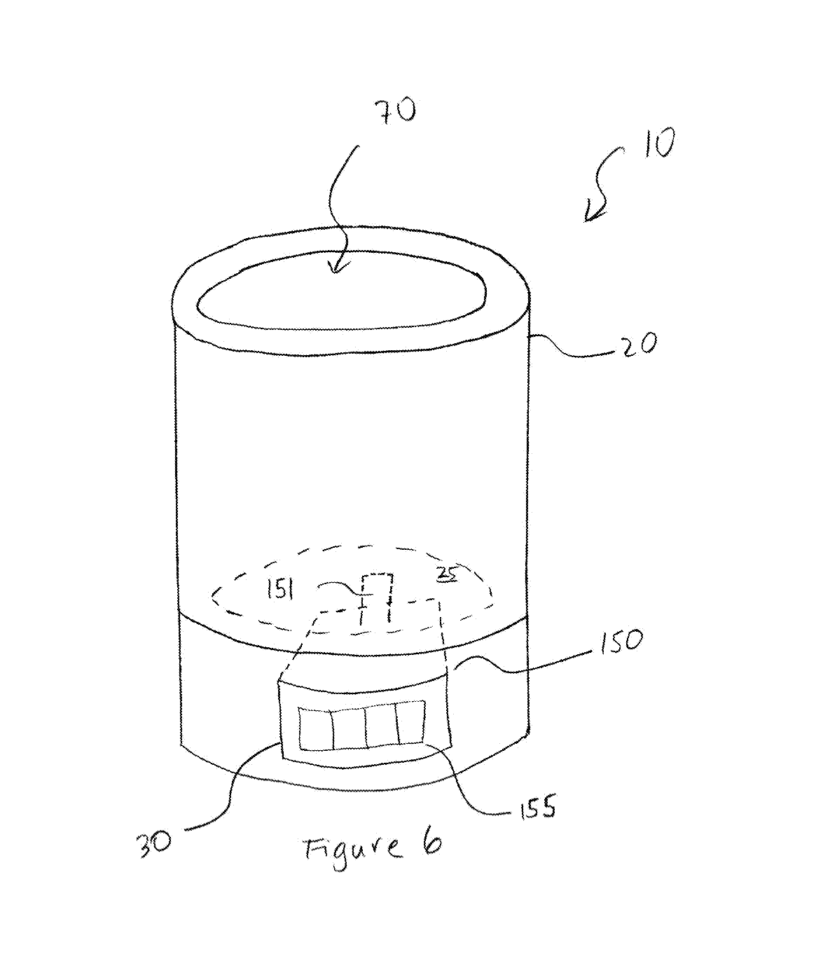

In the embodiment illustrated in FIG. 6, a mechanical counter 150 is disposed beneath the bottom surface of the interior space of the sleeve 70 such that a lever 151 can extend upward from the bottom surface 25 of the sleeve. In a similar concept as described with respect to FIG. 5, the protruding lever protrudes sufficiently to make contact with the bottom surface of various containers, including containers with concaved bottom surfaces. When a beverage container is inserted into the sleeve, the bottom of the beverage container makes contact with the lever and depresses the lever to increase the count display 155 by one.

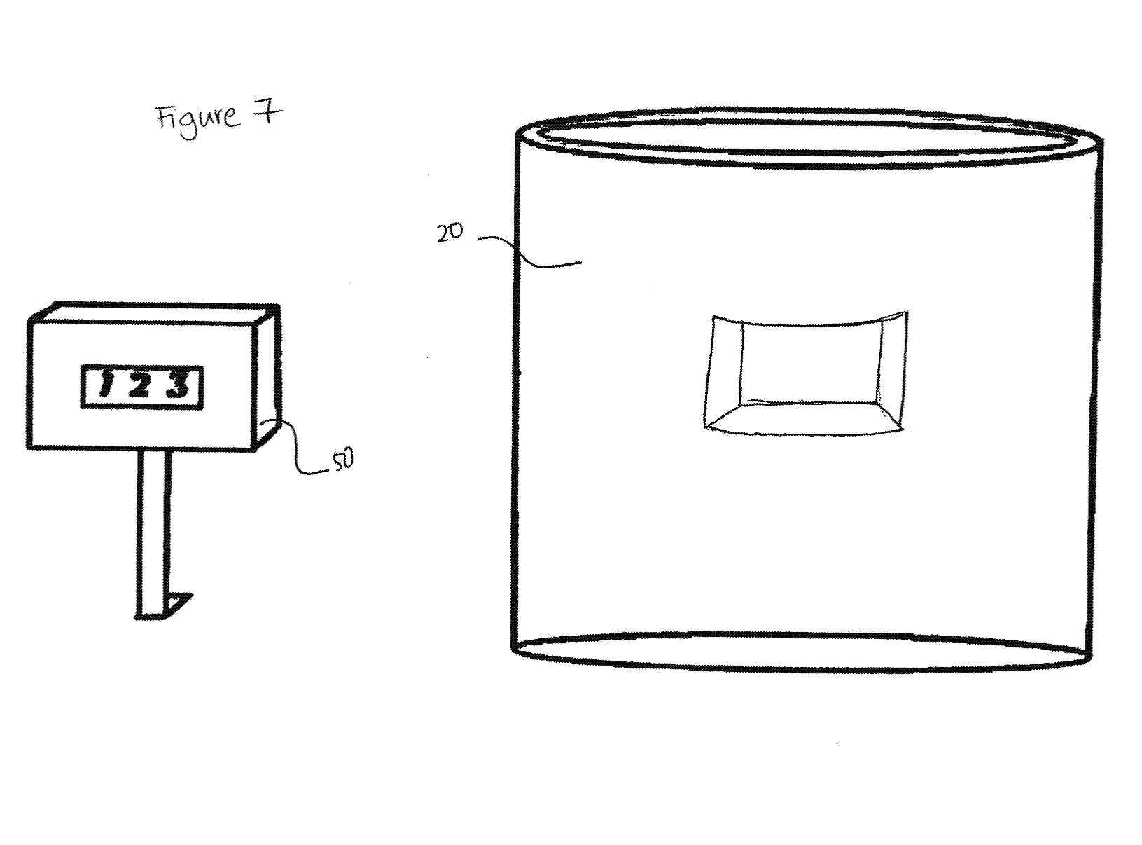

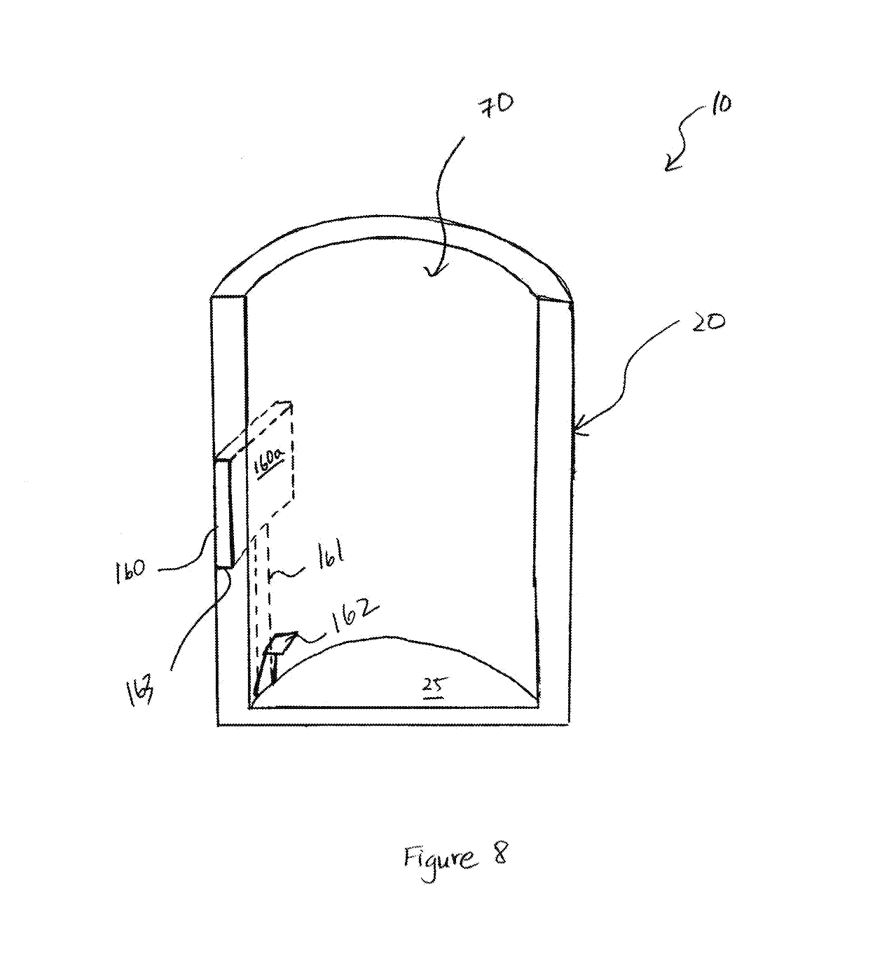

FIG. 7 illustrates an exploded view of a counter 50 removed from the sleeve 20 of the beverage counter. Various other orientations of the different types of counters are possible, as known to one skilled in the art. FIG. 8 illustrates a counting mechanism 160 disposed within a recessed portion 163 on the surface of the sleeve 20. A lever 162, which when depressed increases the count by one, extends into the interior space 70 of the sleeve to make contact with beverage containers. The lever 162 can extend into the interior space 70 directly from the back surface 160a of the counting mechanism, or can extend from a support bar 161 as show in FIG. 8. The counting mechanism illustrated in FIG. 8 is a mechanical counting mechanism, however, the configuration shown in FIG. 8 with having a portion of the counting mechanism 160 being on the exterior surface of the sleeve, can be used with various other types of counting mechanisms.

From the foregoing, it will be observed that numerous variations and modifications may be effected without departing from the spirit and scope of the invention. It is to be understood that no limitation with respect to the specific apparatus illustrated herein is intended or should be inferred.

All references, including publications, patent applications, and patents, cited herein are hereby incorporated by reference to the extent that the references are not inconsistent with the present disclosure and to the same extent as if each reference were individually and specifically indicated to be incorporated by reference and were set forth in its entirety herein.

1. A beverage counting apparatus for use with a beverage container, comprising
a region for contact with the beverage container; and
a counting mechanism engaged with the region for contact such that contact of a beverage container with the region for contact triggers the counting mechanism to increase its count by one, said counting mechanism having a display indicator to display the count number.

2. The beverage counting apparatus of claim 1 wherein the region for contact with the beverage container is a sleeve that surrounds at least a portion of the beverage container.

3. The beverage counting apparatus of claim 2 wherein the display indicator is disposed on the exterior surface of the sleeve.

4. The beverage counting apparatus of claim 3 wherein the display indicator is disposed in a recessed region on the exterior surface of the sleeve.

5. The beverage counting apparatus of claim 2 wherein a trigger for increasing the count by one is disposed within an interior space of the sleeve.

6. The beverage counting apparatus of claim 2 wherein the display indicator is visible through a display window on the sleeve.

7. The beverage counting apparatus of claim 2 wherein the counting mechanism is a mechanical counter.

8. The beverage counting apparatus of claim 7 wherein the mechanical counter comprises a lever which when depressed increases the count by one, and wherein said lever extends into a region of space defined by the sleeve.

9. The beverage counting apparatus of claim 2 wherein the counting mechanism is an electrical counter.

10. The beverage counting apparatus of claim 9 wherein the electrical counter comprises a depressible region which when depressed increases the count by one, and wherein said depressible region extends into a region of space defined by the sleeve.

11. The beverage counting apparatus of claim 2 wherein the counting mechanism is an optical counter.

12. The beverage counting apparatus of claim 11 wherein the optical counter comprises a beam which intersects a region of space defined by the sleeve.

13. A method for keeping count of the number of beverages consumed comprising the steps of:
providing a counting mechanism attached to an enclosing member which comes in contact with a beverage container; and
triggering the counting mechanism to increase by one each time a beverage container is inserted into the enclosing member.

14. The method of claim 13 wherein the counting mechanism is a mechanical counter with a lever which increases the count number by one when depressed; and wherein the step of triggering the counting mechanism comprises the step of causing the lever to be depressed as the beverage container is inserted within the enclosing member.

15. The method of claim 14 wherein the step of causing the lever to be depressed comprises the step of using the beverage container to depress the lever.

16. The method of claim 13 wherein the counting mechanism is an electrical counter with a button which increases the count number by one when depressed; and wherein the step of triggering the counting mechanism comprises the step of causing the button to be depressed as the beverage container is inserted within the enclosing member.

17. The method of claim 16 wherein the step of causing the button to be depressed comprises the step of using the beverage container to depress the button.

18. The method of claim 13 wherein the counting mechanism is an optical counter wherein interruption of a beam sent from a source to a sensor increases the count number by one; and wherein the step of triggering the counting mechanism comprises interrupting the beam with the beverage container as the container is inserted within the enclosing member.
